(19) United States
(12) Patent Application Publication
(10) Pub. No.: US 2005/0118959 A1
(43) Pub. Date: Jun. 2, 2005

(54) Mobile-unit-assisted modulation management

(75) Inventors: Axnas Johan, Solna (SE); Craig Stephen, Nacka (SE); Dayong Chen, Cary, NC (US); Eriksson Stefan, Stockholm (SE)

Correspondence Address: NIXON & VANDERHYE, PC, 1100 N GLEBE ROAD, 8TH FLOOR, ARLINGTON, VA, 22201-4714, US

(73) Assignee: Telefonaktiebolaget LM Ericsson (publ), Stockholm (SE)

(21) Appl. No.: 10/857,360

(22) Filed: Jun. 1, 2004

Related U.S. Application Data
(60) Provisional application No. 60/500,691, filed on Sep. 8, 2003.

(51) Int. Cl. H04B 17/00; H04B 1/02; H04B 1/66

(52) U.S. Cl. 455/67.11; 455/115.3; 455/226.2; 455/102; 455/205

(57) ABSTRACT

The invention discloses a mobile-unit-assisted modulation scheme management, in which a mobile unit (100) performs signal quality measurements on a communications link (410), over which data modulated with a first modulation scheme is communicated. The mobile unit (100) determines a first link quality measure for this first modulation. Furthermore, the mobile unit (100) estimates second quality measure(s) for currently non-employed modulation scheme(s) based on this first quality measure. Selection information is then generated based on this first quality measure and the second quality estimate(s). This quality measure estimation is performed based on the capabilities and the particular modulation scheme versions of the mobile unit (100).

### TECHNICAL FIELD

The present invention generally relates to modulation scheme management in radio communications systems, and in particular to a mobile-unit-assisted modulation scheme management in such systems.

### BACKGROUND

Radio communications systems of today typically employ a modulation scheme, in which an intelligence-bearing signal is superimposed or mixed into a propagating carrier signal.

For some communications systems, including a GSM (Global System for Mobile Communications) or GPRS (General Packet Radio Service) system, the sole choice of available modulation scheme has been the GMSK (Gaussian Minimum Shift Keying). GMSK is a kind of constant-envelope phase modulation, where transmitting a zero bit or one bit is represented by changing the phase. Thus, every transmitted symbol represents one bit.

Introduction of the EDGE (Enhanced Data rates for GSM Evolution) technology into a GPRS systems provides another modulation scheme to be employable for radio communications, namely 8-PSK (8-state Phase Shift Keying). 8-PSK enables reuse of the channel structure, channel width and the existing mechanisms and functionality of the GMSK-using GPRS system. However, 8-PSK enables higher bit rates per time slot than those available for GMSK. 8-PSK is a linear method that uses phase and amplitude modulation, in which three consecutive bits are mapped onto one symbol. Although the symbol rate remains the same as for GMSK, each symbol now represents three bits instead of one, thus, increasing the raw data rate by a factor of three.

An EGPRS (Enhanced GPRS) system having access to both GMSK and 8-PSK modulation can use nine different modulation coding schemes, MCS1 to MCS9. The lower four coding schemes use GMSK whereas the upper five use 8-PSK. These nine MCS use different error correction and, consequently, are adapted for usage under different radio environment conditions. Generally, in good radio environments a more aggressive (less error correction, 8-PSK-associated) coding scheme can be used to provide a higher user data rate, whereas with a poor radio link environment a coding scheme with more error correction (GMSK-associated MCS) and lower user data rate is typically used.

The EGPRS system also employs link quality control functionality denoted link adaptation. Link adaptation uses radio link quality measurements from a mobile unit and/or base transceiver station to select the most appropriate modulation coding scheme for downlink and uplink transmission. In particular for a mobile unit, such a measurement report includes only link quality measurements or estimations, e.g. BEP (Bit Error Probability), for the modulation that has been used since a last measurement report. However, since the link quality measurements are dependent on the particular modulation scheme employed, the network has to make an assumption about the relative performance of GMSK modulation and 8-PSK modulation. For example, if the network receives a report with BEP for data received by the mobile unit and modulated by GMSK, the network “maps” this GMSK BEP to a corresponding estimated 8-PSK BEP value.

A major problem with this prior art procedure is that a single modulation scheme BEP mapping is used for all mobile units in the system. However, the relative performance of GMSK and 8-PSK modulation is typically different in mobile units from different manufacturers and may also vary from one radio environment to another. Thus, the network may in some instance select a non-optimum modulation coding scheme to use for data transmitted to a mobile unit because of this non-ideal or erroneous BEP modulation mapping.

### SUMMARY

The present invention overcomes these and other drawbacks of the prior art arrangements.

It is a general object of the present invention to provide an improved modulation scheme management in communications systems.

It is another object of the invention to provide a mobile-unit-assisted management of modulation scheme selection in communications systems.

Yet another object of the invention is to provide more accurate decision information used in the selection of modulation scheme for mobile units in communications systems.

These and other objects are met by the invention as defined by the accompanying patent claims.

Briefly, the present invention involves a mobile-unit-assisted generation of modulation-scheme-dependent link quality data used as a basis for selection of a modulation to use on data transmitted to the mobile unit. In a communications system, in which the invention is applied, a mobile unit has multiple available modulation schemes that are used for modulating data communicated on a communications link between the mobile unit and a base station. Since the performance of the different modulation schemes depends on the radio environment, the selection of a scheme to employ will be based on a link quality measure for the communications link. Such a link quality measure is, though, dependent on the modulation scheme employed for the link.

According to the invention, the mobile unit performs signal quality measurements on the communications link, over which data modulated using a first modulation scheme is communicated. The mobile unit then determines a first link quality measure for this first modulation. This first quality measure and/or the measurements of the link quality for the first modulation are used by the mobile unit for estimating a corresponding link quality measure for at least a subset of the other (currently not employed) available modulation schemes. This link quality estimation can then be performed based on the specific capabilities of the mobile unit, in particular based on the specific types and versions of modulation schemes and/or receiver algorithms implemented in the unit. This will result in a much more accurate quality measure estimation than if a central unit in the communications system would perform such estimation on behalf of all connected mobile units, which typically have different modulation capabilities and employ different modulation scheme and receiver algorithm versions. The mobile unit further generates selection information based on this first link quality for the currently used modulation scheme and the second estimated link quality/qualities for the currently not used modulation(s). The selection information is reported to the (central) unit in the communications system performing the selection and decision of modulation schemes for mobile units in the system.

The selection information could include determined link quality measures for the different modulations. Alternatively, it includes only one of the quality measures, typically the measure associated with the currently employed modulation, and a quantity derived from the link quality measures. The mobile unit could alternatively perform the modulation scheme selection itself based on the determined quality measures. In such a case, the selection information includes an identification of the selected and, thus, presently most preferred modulation scheme. The selection information could also include a corresponding identification of a presently preferred modulation coding scheme (MCS) associated with the selected modulation.

The estimation of the second link quality measure(s) based on the measured and determined first link quality measure can be realized by a quality measure mapping or converting process in the mobile unit. For example, a link quality map or table can be provided in the mobile unit. This table lists different link quality values for the first modulation and the corresponding values for the other modulation scheme(s). The mapping between quality measures is then performed as a table look-up using the determined first quality measure in order to obtain an estimation of the second quality measure(s). Alternatively, a converting function could be used with the first quality measure as input data and then outputting a corresponding quality measure for the currently not employed modulation(s). The table or function is preferably determined based on the particular capabilities and modulation scheme versions of the mobile unit and can be prepared using laboratory measurements and simulations on the mobile unit and/or the modulation hardware/software of the unit.

Since the different modulation schemes can be associated with different transmission power levels, the base station transmitting data to the mobile unit preferably reports the power levels, or quantities derived therefrom, to the mobile unit. This power data will then be used in the estimation of the second link quality measure(s) in order to obtain more accurate estimations.

The base station could also be configured to intermittently or periodically transmit data modulated with one of the otherwise currently non-employed modulation schemes. This allows the mobile unit to also perform link quality measurements on data modulated with these schemes. These measurements are then used together with the first link quality measure in the estimation of the second link quality measure(s).

The mobile unit could be equipped with a link quality enhancing algorithm that is operable on data modulated using a specific modulation scheme, or a specific subset of the available schemes. This enhancing algorithm will then improve the link quality experienced by the mobile unit when data is modulated with the specific modulation scheme(s) but not with other schemes. The mobile unit preferably determines the performance gain (quality enhancement) due to this algorithm. This gain is used in the estimation of the second link quality measure(s) in order to obtain even more accurate estimations.

The invention offers the following advantages:
Improves the accuracy in estimating link quality measures for both currently employed and currently not employed modulation schemes;
Allows the network to select, at any time instant, the optimal modulation scheme for a mobile unit;
Enhances the user bit rate;
Improves the communications system capacity; and
Facilitates smooth transitions between different modulation schemes.

Other advantages offered by the present invention will be appreciated upon reading of the below description of the embodiments of the invention.

### SHORT DESCRIPTION OF THE DRAWINGS

The invention together with further objects and advantages thereof, may best be understood by making reference to the following description taken together with the accompanying drawings, in which:

FIG. 1 is a schematic overview of a portion of a radio communications system, to which the teachings of the present invention can be applied;

FIG. 2 is a schematic block diagram illustrating an embodiment of a mobile unit according to the present invention;

FIG. 3 is a schematic block diagram illustrating the link quality estimator of FIG. 2 in more detail;

FIG. 4 is a schematic block diagram illustrating another embodiment of a mobile unit according to the present invention;

FIG. 5 is a schematic block diagram illustrating yet another embodiment of a mobile unit according to the present invention;

FIG. 6 is a schematic block diagram illustrating an embodiment of the link quality enhancement generator of FIG. 5 in more detail;

FIG. 7 is a schematic block diagram illustrating another embodiment of the link quality enhancement generator of FIG. 5 in more detail;

FIG. 8 is a schematic block diagram of a packet control unit according to the present invention;

FIG. 9 is a flow diagram illustrating the selection information generating method according to the present invention;

FIG. 10 is a flow diagram illustrating the step of estimating link quality of FIG. 9 in more detail;

FIG. 11 is a flow diagram illustrating additional steps of the method of FIG. 9;

FIG. 12 is a flow diagram illustrating an additional step of the method of FIG. 9;

FIG. 13 is a flow diagram illustrating an embodiment of the step of generating link quality enhancement of FIG. 12 in more detail;

FIG. 14 is a flow diagram illustrating another embodiment of the step of generating link quality enhancement of FIG. 12 in more detail, and

FIG. 15 is a flow diagram illustrating an additional step of the method of FIG. 9.

### DETAILED DESCRIPTION

Throughout the drawings, the same reference characters will be used for corresponding or similar elements.

In several radio communications systems of today different modulation schemes or techniques are employed for modulating data transmitted on radio communications links through the systems. In cases of multiple available modulation schemes, the selection of an actual modulation scheme to use is then typically based on the radio quality of the communications link. The present invention relates to performing such a modulation scheme selection.

In the following, the invention will be described and disclosed with reference to a radio communications system having access to two possible modulation schemes, GMSK (Gaussian Minimum Shift Keying) and 8-PSK (8-state Phase Shift Keying). However, the invention is not limited to this actual choice of modulation schemes or to communications systems having access to only two different modulation schemes, but can be applied to a general communications system that that can use multiple, i.e. at least two, different modulation schemes for processing data communicated through the system, e.g. a CDMA (Code Division Multiple Access) system using QPSK (Quadrature PSK), 16QAM (16 Quadrature Amplitude Modulation) and 64QAM.

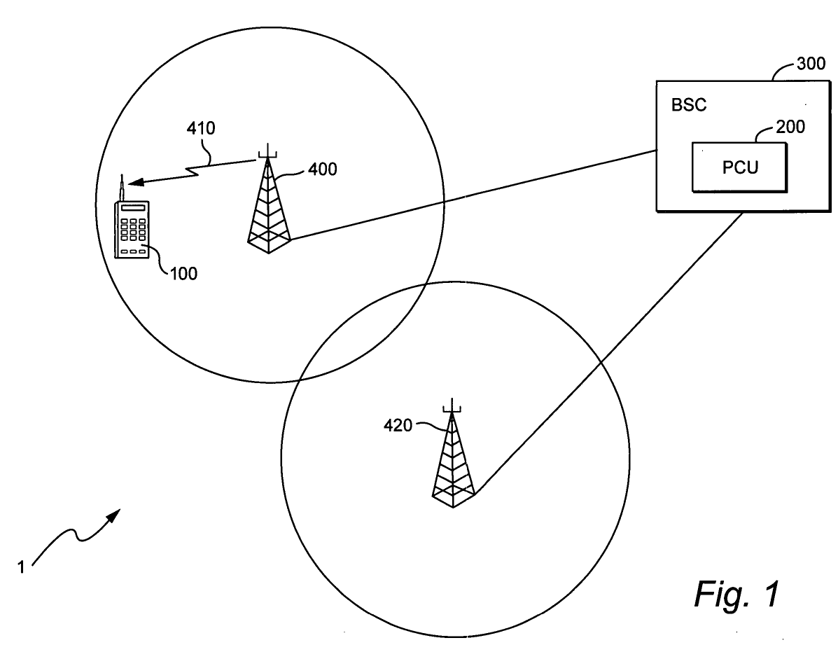

FIG. 1 is a schematic overview of a portion of a radio communications system 1, to which the teachings of the invention can be applied. In FIG. 1, only units directly involved in the present invention are illustrated in order to simplify the figure. The radio communications system 1 could be a GPRS (General Packet Radio System) system adopting the EDGE (Enhanced Data rates for GSM Evolution) technique or an EGPRS (Enhanced GPRS) system. Generally, the communications system 1 comprises a number of base stations (BS) or base transceiver stations (BTS) 400, 420 providing communications links to connected mobile units 100. These base stations 400, 420 are typically connected to and controlled by a base station controller (BSC) 300 or radio network controller (RNC). This BSC 300 in turn includes functionality or units 200 for selecting modulation schemes to use for the communications link 410 to the mobile units based on link quality measurements or estimations from the mobile units 410 and/or the base stations 400, 420. In the figure, this modulation scheme selecting unit is, non-limitedly, represented by a packet control unit (PCU) 200.

During operation, the mobile unit 100 performs signal or link quality measurements for the (downlink) communications link or channel 410 with its associated base station 400. Based on these measurements a link quality measure is determined or estimated. This determined link quality measure is, however, dependent on the modulation scheme that was used and applied to the data received on the link 410. Since the selection of modulation scheme to use on a communications link is based on the link quality and this link quality in turn depends on the employed modulation scheme, a corresponding link quality measure for the presently non-employed modulation scheme(s) has to be estimated in order to perform a correct scheme selection.

In the prior art systems, this estimation of link quality for the non-employed modulation scheme(s) is performed in the PCU 200, whereas according to the present invention it is performed in and by the mobile unit 100. As was discussed in the background section, employing a central PCU-based mapping or conversion between the link qualities for the different modulation schemes may result in a non-optimal choice of modulation scheme for a mobile unit. This is because the relative performances of the different modulation schemes typically differ from different mobile unit types and different manufacturers. By then implementing the determination of the modulation-dependent link qualities in the mobile unit 100, the particular capabilities of that mobile unit 100, e.g. the actual performance difference between modulation schemes and receiver algorithms, will be taken into consideration during the link quality mapping. As a result a much more accurate selection of modulation scheme can be performed.

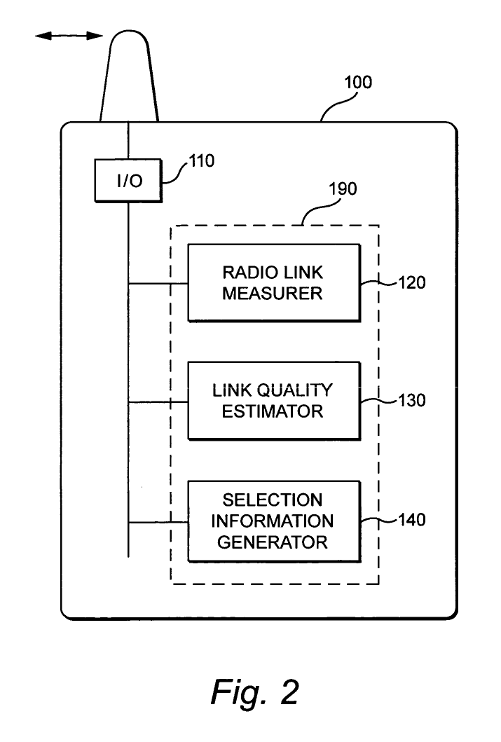

FIG. 2 is a schematic block diagram of an embodiment of a mobile unit 100 according to the present invention. The mobile unit 100 includes an input and output (I/O) unit 110 for conducting communication with external units and stations. This I/O unit 110 is in particular configured for receiving radio blocks with modulated data from a base station, to which the mobile unit 100 is connected.

The mobile unit 100 further includes a radio link measuring unit or measurer 120 that performs signal measurements on the radio or communications link with the base station. This measuring unit 120 also determines a link quality measure that depends on the modulation scheme presently used for the data received on the link. For example, if GMSK modulation is presently used, the radio link measurer 120 will determine a first GMSK-dependent link quality measure. However, if 8-PSK instead would be used, the radio link measurer 120 would generate a second typically different 8-PSK-dependent link quality measure even though the radio environment would be identical for the two modulation schemes.

The radio link measuring unit 120 preferably performs the link measurements on each received burst or radio block and generates the first link quality measure based on these measurements. Alternatively, the measuring unit 120 could be configured for intermittently or periodically performing the signal measurements, e.g. on every second received radio block or every second 100 ms, or some other periodical interval.

The first link quality measure for the presently employed modulation scheme could be expressed in terms of bit error probability (BEP) or some other signal or link quality measure used in the art.

In a preferred embodiment of the invention, the link quality measure is an average quality measure, e.g. average BEP, over multiple received bursts or over a given period of time. This average quality measure could be a weighted average measure using different weights for different received radio blocks. In such a case, a weight used in the measurements in connection with a recently received radio block is then preferably larger than the corresponding weight for a radio block received earlier. Thus, the weighted average link quality measure should, as accurately as possible, reflect the current radio quality environment and situation for the communications link.

Although, the radio link measurer 120 has been described as determining or estimating one link quality measure for a first, presently used, modulation scheme, this measurer 120 could alternatively determine multiple link quality measures associated with this first modulation scheme. For example, the measure could include the average BEP and a coefficient of variation of the BEP, which both will be dependent on the used modulation scheme. Thus, in the present invention, when a modulation-scheme-dependent link quality measure is discussed this also includes multiple related measures associated with the given modulation scheme.

In the following it is assumed that the presently employed modulation scheme for the communications link is GMSK so the radio link measurer 120 will determine a GMSK-dependent link quality measure. Thus, the currently non-employed modulation scheme will then be 8-PSK in the present example. However, this should merely be seen as an illustrative example and the invention can also be applied to cases where 8-PSK or some other modulation scheme is currently used for downlink data to the mobile unit 100.

A link quality estimating unit or estimator 130 is provided in the mobile unit 100 for estimating the corresponding link quality measure for the non-employed modulation scheme, i.e. 8-PSK-dependent link quality measure in the present example. This estimator 130 is configured for estimating the 8-PSK-dependent link quality measure based on the GMSK-dependent link quality measure determined by the radio link measurer 120 and/or based on the GMSK-dependent link quality measurement results obtained from this measurer 120.

If the radio communications system can use three or more different modulation schemes, the estimator 130 could then be configured for estimating the modulation-scheme-dependent link quality for at least one of these non-used schemes and preferably for all of those schemes.

In a first embodiment, the link quality estimator 130 is configured for generating a corresponding link quality measure for the 8-PSK modulation as the measurer 120 has done for the GMSK modulation. This means that if the GMSK-dependent measure is represented as BEP, the estimator generates an 8-PSK-dependent BEP value based on the GMSK-measure. Correspondingly, if the GMSK measure instead is represented as average BEP and coefficient of variation, the estimator 130 generates an 8-PSK-dependent average BEP and coefficient of variation.

In an alternative embodiment, the base station, to which the mobile unit 100 is connected, is caused to intermittently or periodically transmit radio blocks or data modulated using 8-PSK even though GMSK should presently be used, and vice versa. However, if the present modulation is GMSK, intermittently transmitting 8-PSK blocks, which has a higher probability of getting lost than corresponding GMSK blocks, might result in that the mobile unit (100) will not detect these 8-PSK blocks. This problem may be lessened by the base station choosing the most appropriate modulation coding scheme (MCS) associated with 8-PSK, e.g. MCS5 having a lower loss probability than the remaining 8-PSK-associated MCS (MCS6-9).

By then providing some 8-PSK modulated data, 8-PSK-dependent measurements can be performed thereon by the measurer 120, which then forwards such measurement results to the estimator 130. This link quality measurer 130 then uses these 8-PSK-measurements in addition to the GMSK-dependent link quality data from the measurer 120 in the process of determining a corresponding 8-PSK-dependent link quality measure. Thus, basing this link quality estimation on actual measurement results for the given modulation scheme typically provides a more accurate estimation than by only using measurements for other modulation schemes. This inclusion of radio blocks modulated with a currently non-optimal modulation scheme for the purpose of producing more accurate link quality measurements can be straightforwardly implemented for downlink communications. For example, in cases where GPRS and EGPRS are mixed, transmission with GMSK is already normally used every Xth block, where X is a positive number larger than one, e.g. four, even when 8-PSK is used in order to enable uplink state flag (USF) decoding by the mobile unit.

In yet another embodiment, the link quality estimator 130 is configured for generating a less detailed measure for the non-used 8-PSK link quality than the presently used GMSK modulation. For example, if the GMSK link quality measure from the radio link measurer 120 is represented as average BEP and coefficient of variance, the corresponding 8-PSK measure could simply be a BEP value. Alternatively, a single 8-PSK-dependent value could be used to represent an interval of GMSK link quality values. For example, if the is determined GMSK-dependent measure is within the interval X₁<GMSK-measure<X₂, X₁<X₂ are real numbers, the corresponding estimated 8-PSK-dependent measure should be Y₁, whereas if X₂<GMSK-measure<X₃ Y₂ should be selected as 8-PSK-dependent measure, Y₁, Y₂ are real numbers.

In some communications systems, different maximum transmission power levels may be used for GMSK-modulated radio blocks than for 8-PSK-modulated blocks. A reason could be that the power amplifier non-linearities in the base station transmitter are typically more servere for 8-PSK. The base station could then report the used power levels for GMSK and the corresponding level for 8-PSK to the mobile unit 100. Alternatively, a power quantity derived from these power levels, such as ratio between the GMSK power level and the 8-PSK power level, a difference therebetween or some other quantity derived therefrom, could be communicated to the mobile unit 100. The link quality estimator 130 is then configured for using the received power data or quantity in the estimation of the 8-PSK-dependent link quality measure, which will result in a more accurate estimation value.

The GMSK-dependent link quality measure from the radio link measurer 120 and the corresponding 8-PSK-dependent link quality measure from the link quality estimator 130 are then forwarded to a selection information generating unit or generator 140. This unit 140 generates selection information based on these received quality measures. This information will form basis for the selection or decision of which modulation scheme to use for the downlink to the mobile unit 100.

If each received modulation-scheme-dependent link quality measure basically includes multiple values, e.g. an average and a variance value, the generator 140 could be configured to consider all such values or only one or a subset thereof, e.g. the average BEP value of respective modulation scheme, in the information generation.

The selection information can then include the (two) determined modulation-scheme-dependent link quality measures from the measurer 120 and the estimator 130. Alternatively, the information includes the link quality measure for the presently employed modulation scheme (from the measurer 120) and a quantity derived from the link quality measures, e.g. a difference between or a ratio of the GMSK measure and the 8-PSK measure, or some other quantity that allows determination of the 8-PSK measure using the GMSK measure in the selection information.

The generated selection information is then preferably transmitted using the I/O unit 110 to an external unit in the communications system that performs the selection of modulation scheme on behalf of connected mobile units, e.g. the PCU of FIG. 1. The selection information, thus, forms basis for this decision and selection process in the external unit.

As is well known in the art, the two modulation schemes 8-PSK and GMSK are each associated with different modulation and coding schemes (MCS) used for coding the data transmitted over air in the system. As for selection of modulation scheme, the actual choice of a suitable MCS is typically dependent on radio link quality measurements. This means that the selection information can also, or alternatively, be used for selection of an appropriate MCS to use on the downlink to the mobile unit 100.

The selection information generator 140 could be configured for intermittently or periodically transmit the information via the I/O unit 110 to the external unit (PCU). Alternatively, or in addition, the selection information could be reported to the PCU upon reception of a report request therefrom.

The link quality estimator 130 and the selection information generator 140 and possibly the radio link measurer 120 can be implemented in a information generating unit 190 that is adapted for arrangement and operation in the mobile unit.

The units 110 to 140 of the mobile unit 100 may be implemented as software, hardware or a combination thereof.

This, mobile-unit-assisted modulation scheme selection helps the communications network in selecting, at any time instant, the optimal modulation scheme, and hence improve the user bit rate and the system capacity. This embodiment of the invention that reports both 8-PSK-dependent link quality and GMSK-dependent link quality even although only one of the modulation schemes have been used between information-reporting events, also facilitates a more smooth transition between modulation schemes.

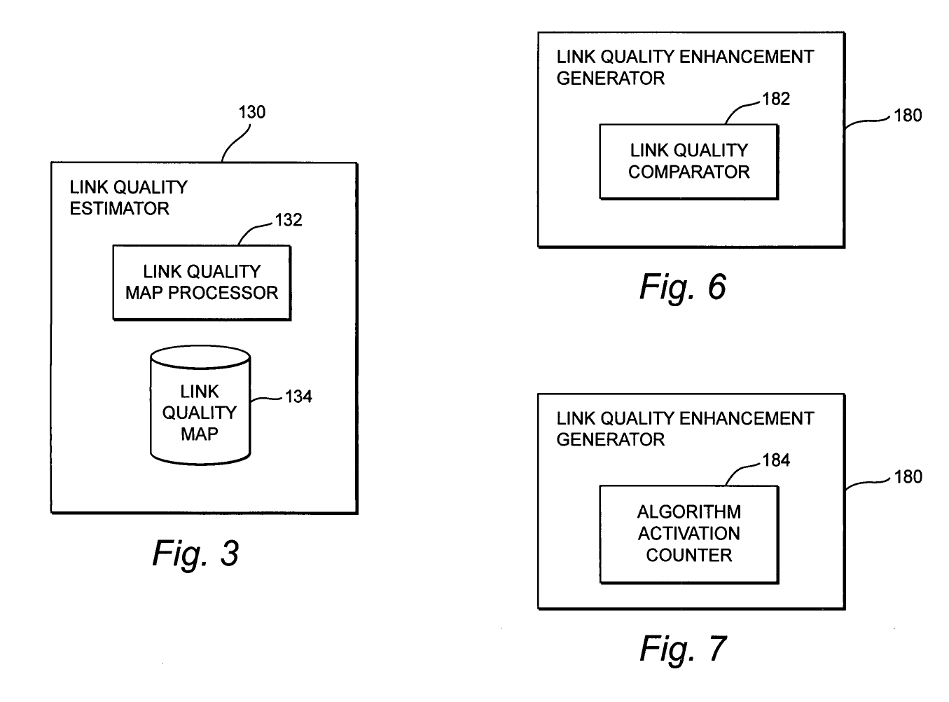

FIG. 3 is a schematic block diagram of an embodiment of the link quality estimator 130 of FIG. 2. This estimator 130 includes a link quality map or table 134 that lists different 8-PSK and GMSK link quality values Such a table 134 then allows mapping or conversion between different modulation-dependent quality values. Thus, for a given GMSK quality value the table 134 includes a corresponding 8-PSK value, and vice versa. This means that when a link quality map processor 132 in the estimator 130 receives a measured and determined GMSK link quality measure from the radio link measurer, the processor 132 performs a look-up in the table 134 and retrieves the corresponding 8-PSK link quality measure.

The table 134 could be implemented to include equally detailed quality measures for the two modulation schemes, e.g. if an average BEP and variance thereof is used for retrieving corresponding 8-PSK measures, an average 8-PSK-dependent BEP and variance may be obtained from the table 134. Alternatively, a less detailed value could be retrieved, e.g. only a single BEP compared to average and variance values. In the case of more than two available modulation scheme, several tables 134 could be implemented in the estimator 130 or a single 134 could list the different link quality values for all of the schemes.

Alternatively, the table 134 is omitted and the processor 132 instead employs a link quality mapping or converting algorithm or function. Such a function then has the GMSK-dependent link quality or GMSK-dependent measurements from the radio link measurer as input parameter and outputs a corresponding 8-PSK-dependent quality measure. Other input parameters, such as 8-PSK measurement results on intermittently received radio blocks and/or power level data from the base station, could also be used in the function in order to obtain a more accurate estimated 8-PSK measure. If the GMSK measure is represented by two values, the function could output a single or two 8-PSK values. It could be possible that one and the same function could be used for both converting GMSK values into 8-PSK values and vice versa. Alternatively, and also if more than two modulation schemes are possible, several different converting functions can be implemented in the processor 132.

The mapping table 134 and/or the function is preferably generated based on the capabilities of the mobile unit, in particular based on the specific version and types of modulation schemes and the receiver algorithm(s) employable in the mobile unit. Such a table or function can be produced based on standard laboratory measurements and/or simulations on the mobile unit or the modulation software and/or hardware implemented in the unit. Having such a mobile-unit-adapted link quality conversion for different modulation schemes enhances the link quality estimation and results in a more accurate selection information than by using a central mapping functionality in network for all types of mobile units.

Thus, the processor 132 is configured for receiving the GMSK measure and possibly other input data, such as 8-PSK measurement results and power level quantity, from other units in the mobile unit or from external unit, and uses them in the generation of the estimated 8-PSK link quality measure.

In a first embodiment of the invention, the table 134 or function is configured for considering the possibly different transmission power levels of GMSK and 8-PSK modulation. This means that the table 134 could for each GMSK value list several 8-PSK values but for different values of the power level quantity Alternatively, the processor 132 could, once an 8-PSK value has been retrieved from the table 134, modify this value based on the power level quantity.

The unit 132 of the link quality estimator 130 may be implemented as software, hardware or a combination thereof. The unit 132 and table 134 may all be implemented in the estimator 130. However, a distributed implementation is also possible, with the unit 132 and/or table 134 provided in elsewhere in the mobile unit.

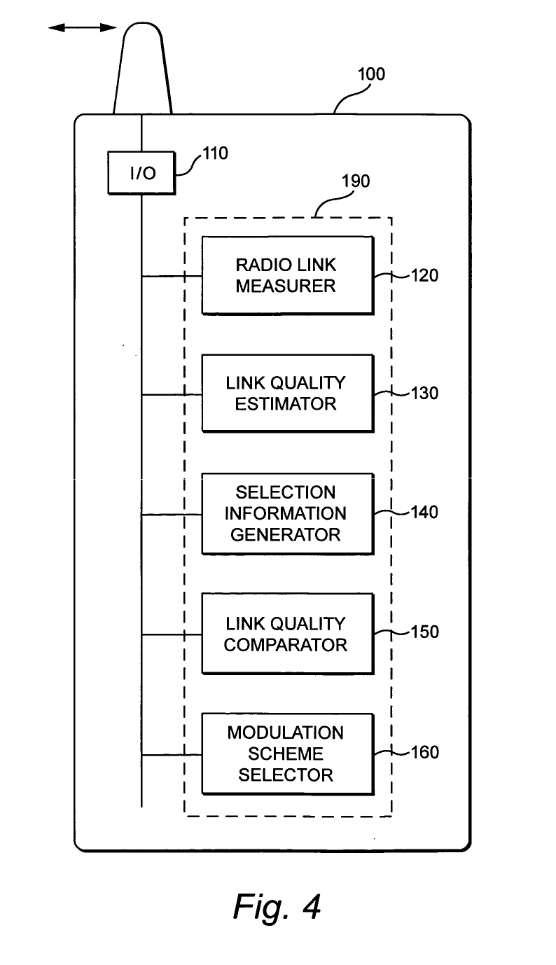

FIG. 4 is a schematic block diagram illustrating another embodiment of a mobile unit 100 according to the present invention. The I/O unit 110, radio link measurer 120 and link quality estimator 130 are similar to the corresponding units in FIG. 2 and are not further discussed herein.

The mobile unit 100 includes a link quality comparing unit or comparator 150 that receives the GMSK-dependent link quality measure from the measurer 120 and the corresponding estimated 8-PSK-dependent measure from the estimator 130. A modulation scheme selector 160 then selects one of these modulation schemes based on the comparison. This selector 160 typically selects the modulation scheme giving rise to a best link quality for the communications link based on the comparison performed by the comparator 150. The selector 160 also generates a notification or identification of the selected modulation scheme. In cases with only two possible schemes, such as GMSK and 8-PSK, a single bit can be used to represent the selected and presently preferred modulation. However, if more than two modulations are accessible for the mobile unit 100, more than one bit may have to be used for the identification of the selected modulation.

Furthermore, the selector 160 could also be configured for selecting, in addition to a suitable modulation scheme, a modulation and coding scheme to use on the communications link. Also this selection is based on the operation of the comparator 150 on the input link quality measures. The selector 160 can then, or in addition, generate a notification or identification of the selected MCS.

This identification (or identifications) is then brought to the selection information generator 140. Thus, in this embodiment of the invention the mobile unit 100 itself performs the selection of modulation scheme and/or MCS to use and the selection information transmitted to the PCU then includes the result from this selection, i.e. the identification(s). The PCU could choose to use the proposed modulation scheme and/or MCS in the received report from the mobile unit 100 for the communications link between the unit 100 and the base station.

In addition, the selection information could also include the link quality measures as discussed above in connection to FIG. 2. The unit (PCU) receiving the report with the selection information could then optionally perform a similar link quality comparison and modulation scheme and MCS selection. It might be possible that the PCU proposes another selection of modulation scheme and/or MCS than the mobile unit 100. This may be due to that the PCU have access to additional input data, e.g. power level data, that is not accessible for the mobile unit 100 so that the PCU can perform a more accurate selection.

The information generating unit 100 can in this embodiment, thus, include the link quality comparator 150 and the modulation scheme selector 160 in addition to the link quality estimator 130, the selection information generator 140 and possibly the radio link measurer 120.

The units 110 to 160 of the mobile unit 100 may be implemented as software, hardware or a combination thereof.

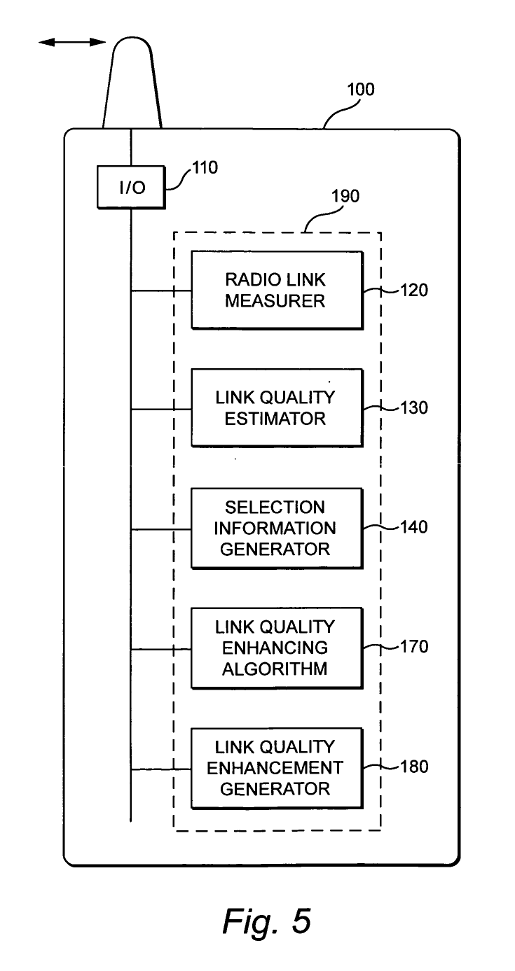

FIG. 5 is a schematic block diagram of yet another embodiment of a mobile unit 100 according to the present invention. The I/O unit 110, radio link measurer 120 and link quality estimator 130 are similar to the corresponding units in FIG. 2 and are not further discussed herein.

This mobile unit 100 embodiment has access to a link quality enhancing algorithm or unit 170 that is applicable for data modulated using a subset of the available modulation schemes. For example, the link quality enhancing algorithm 170 could only be operational on GMSK-modulated data but not 8-PSK-modulated data. Typically, such an enhancing algorithm 170 allows usage of a given modulation scheme even under radio conditions that otherwise would not be possible due to a too low link quality. This means that the algorithm 170 is able to enhance the link quality on the communications link experienced by the mobile unit 100 during usage of one or a subset of the modulation schemes. For example, the enhancing unit 170 could have interference suppressing capability or some other functionality for link quality enhancement.

Since the quality enhancing algorithm 170 is applicable only to a subset of the available modulation schemes, it will affect the link quality measures for this/these modulation scheme(s) but typically not for other modulations. This means that if the obtained link quality enhancement is not considered in the modulation selection process a non-optimal modulation could be selected.

Furthermore, the gain or performance of the enhancing algorithm 170 could also be dependent on the actual radio environment, e.g. on the number and relative strength of interfering signals, and/or traffic load. This means that the selection will be even more insecure if the current link quality gain or enhancement is not used.

Non-limiting examples of such link quality enhancing algorithms 170 that can be applicable according to the invention are Single Antenna Interference Cancellation (SAIC) and Single Antenna Interference Rejection (SAIR).

For example, the current SAIC algorithms only give performance gains when the carrier or link is GMSK modulated. Furthermore, the gain from SAIC depends strongly on the number and relative strengths of the interfering signals. This means that some SAIC algorithms presently may improve the GMSK performance by anything between 0 and 9 dB depending on the radio environment and the SAIC algorithm version employed. Thus, the relative performance between GMSK and 8-PSK is uncertain by up to 9 dB if SAIC gain is not used in the selection process. Therefore, it will be very difficult to conduct an accurate modulation scheme selection without knowledge of the SAIC performance.

As an example of the potential problem, consider downlink transmission where the currently selected MCS is GMSK-modulated. Further assume that the radio environment is suitable for SAIC and that the C/I is high enough to give link quality reports from the mobile unit indicating very good quality, i.e. very low GMSK BEP is reported to the network or PCU. The PCU, which does not know that SAIC is an important reason for the low GMSK BEP will switch to 8-PSK. Since SAIC does not give gains with 8-PSK modulation, there will be many block errors and many blocks may be lost before the PCU receives a new link quality report from the mobile unit and realizes this and switches back to GMSK modulation. There may then be extensive switching back and forth between the modulations (ping-pong effect), in the worst case resulting in about 50% of the blocks being retransmitted.

Thus, a link quality enhancement generator or generating unit 180 is preferably implemented in the mobile unit 100 for determining the quality enhancement caused by operation of the algorithm 170. The generator 180 typically determines such an enhancement as the obtained performance gain.

This could be the average gain over multiple radio blocks or over a certain period of time, e.g. average gain since a last measurement report was generated and transmitted to the PCU. Since the enhancement algorithm 170 is typically activated in some bursts and deactivated in other bursts, the mobile unit 100 can choose simply to estimate link quality with enhancement gain from all received bursts modulated with the modulation scheme associated with the algorithm and link quality without the enhancement gain from only these bursts where the algorithm is deactivated. These two link qualities can then be used to determine the performance gain of the algorithm 170.

The selection information determined by the generator 140 is determined based on this link quality enhancement value and/or the enhancement value is basically included in the information. For example, the selection information could then include the 8-PSK-dependent link quality measure, the GMSK-dependent link quality measure as determined with activation of the link quality enhancing algorithm 170 and the generated enhancement value. Alternatively, the information includes the 8-PSK-dependent link quality measure, the GMSK-dependent link quality measure as determined with activation of the link quality enhancing algorithm 170 and the GMSK-dependent link quality measure as determined without usage of the link quality enhancing algorithm 170.

As was discussed above, once the selection information is determined by the generator 140 it is included in a measurement report transmitted by the I/O unit 110 to the PCU. The teachings of this embodiment of the mobile unit 100 may also be combined with the embodiment of the mobile unit discussed in connection with FIG. 4. Thus, the mobile unit 100 selects a suitable modulation scheme based on the measured and estimated link quality measures and the determined link quality enhancement.

In this embodiment, the information generating unit 190 includes the link quality enhancing algorithm 170, the link quality enhancement generator 180 in addition to the link quality estimator 130, the selection information generator 140 and possibly the radio link measurer 120.

The units 110 to 140 and 170 to 180 of the mobile unit 100 may be implemented as software, hardware or a combination thereof.

FIG. 6 is a schematic block diagram of an embodiment of the link quality enhancement generator 180 of FIG. 5. In this embodiment, the link quality for the modulation scheme(s), to which the enhancing algorithm can be applied, is determined both without activation of the algorithm and with operation of the algorithm. This means that for this/these modulation scheme(s) generally two link quality measures are determined, where the one determined with activation of the algorithm typically is the better one, i.e. smaller if the measure is represented as BEP. A link quality comparator or comparing unit 182 is implemented in the enhancement generator 180 for comparing these two link quality measures for a modulation scheme. The link quality enhancement could be expressed as a difference between the quality measures or as a ratio of them.

The unit 182 of the link quality enhancement generator 180 may be implemented as software, hardware or a combination thereof. The unit 182 may be implemented in the generator 180. However, a distributed implementation is also possible, with the unit 182 provided in elsewhere in the mobile unit.

FIG. 7 is a schematic block diagram of another embodiment of the link quality enhancement generator 180 of FIG. 5. This embodiment includes an algorithm activation counter 184. As was discussed above, the link quality enhancing algorithm is typically activated for some received bursts or radio blocks but not for others. For example, SAIC can potentially be activated for all received GMSK-modulated radio blocks. However, due to external radio environmental conditions SAIC is typically deactivated in situations where it would not result in any performance enhancement or would worsen the link quality. By counting the number of potential radio blocks for which the algorithm is activated, the counter 184 can determine an activation ratio.

Such a ratio could e.g. be defined as the number of radio blocks for which the algorithm was activated divided by the total number of blocks for which the algorithm actually could have been activated, i.e. all received GMSK blocks in the case of SAIC. Such an activation ratio could be an (rough) indication of the link quality enhancement caused by the algorithm. The activation ratio can also optionally be supplemented with data of the average performance gain obtained by the operation of the algorithm in order to define a more accurate quality enhancement. Alternatively, laboratory measurements can have been performed to determine, on average, what performance gain a certain activation ratio corresponds to. For example, an activation ratio of 75% could be used to represent a gain of 7 dB, or a given average gain, e.g. 7 dB could be represented by an interval of activation ratio, e.g. 100-75%. This means that if the counter 184 determines the ratio to be 83%, the algorithm results in a link quality enhancement of 7 dB in this illustrative example.

The unit 184 of the link quality enhancement generator 180 may be implemented as software, hardware or a combination thereof. The unit 184 may be implemented in the generator 180. However, a distributed implementation is also possible, with the unit 184 provided in elsewhere in the mobile unit.

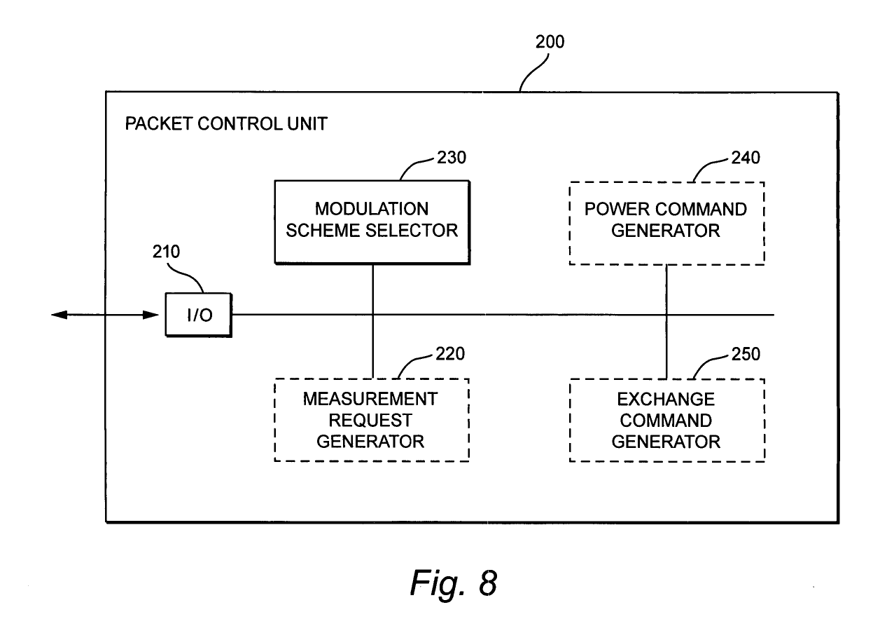

FIG. 8 is a schematic block diagram of a unit performing the selection of modulation schemes on behalf of mobile units in the network. In the figure this unit is, non-limitedly, represented by a packet control unit 200. The PCU 200 includes an I/O unit 210 for conducting communications with external units. The I/O unit 210 is in particular configured for receiving link quality measurement reports from mobile units connected to the communications system. Furthermore, the I/O unit 210 could also transmit requests for such reports to mobile units, unless the mobile units are not configured for automatically transmitting such reports.

An optional measurement request generator 220 is implemented in the PCU 200 for generating the request messages that the I/O unit 210 transmits to mobile units, possible via base stations. The generator 220 could be configured for intermittently or periodically generating these reports. However, if the mobile units automatically transmit such reports to the PCU 200, without the need of received requests, this generator 220 could be omitted from the PCU 200.

The PCU 200 also includes a modulation scheme selector 230 that selects a modulation scheme to use on the (downlink) channel to a mobile unit based on selection information from the mobile unit. Thus, the received selection information constitutes basis for selection, which the selector 230 uses in its decision process. As was discussed in the foregoing, the selection information could include: 1) GMSK and 8-PSK link quality; 2) one of GMSK and 8-PSK link quality plus a quantity derived from the GMSK and 8-PSK link quality; 3) in case of more than two possible modulation schemes, the link quality for at least two of the schemes and preferably from all of the available schemes; 4) the data according to any of 1) to 3) plus a link quality enhancement; 5) the data according to any of 1) to 3) plus an activation ratio for an link quality enhancing algorithm; 6) indication of a preferred modulation scheme; 7) indication of a preferred MCS; 8) indication of a preferred modulation scheme and MCS; or 9) a combination of any of the data according to 1) to 8).

The selector 230 could also be configured for selecting a MCS based on the selection information.

If the received selection information has not been generated by the mobile unit based on power level considerations, i.e. the fact that the transmission power levels of the base station could differ for different modulation schemes, the selector 230 could use such power data in the selection process. An optional power command generator 240 transmits a power level request to the base station communicating with the mobile unit. This request urges the base station to return power level data to the PCU 200. The selector 230 could then modify the link quality measures from the mobile unit based on such received power data in order to obtain even more accurate quality measures that, thus, enable a more accurate modulation scheme selection.

The power command generator 240 could also, or alternatively, transmit power commands to the base station and urging the station to report the power level data to the mobile unit instead of or as a complement to reporting the data to the PCU 200.

An optional unit 250 for generating modulation scheme exchange commands could also be implemented in the PCU 200. This unit 250 intermittently or periodically transmits exchange commands to a base station, urging the station to intermittently or periodically transmit data to a mobile unit, which data is modulated with a presently not employed modulation scheme. This temporary modulation scheme exchange allows the mobile unit to perform link quality measurements on data modulated using an otherwise currently not employed modulation and, thus, allows a more accurate estimation of the link quality for that modulation.

The units 210 to 250 of the PCU 200 may be implemented as software, hardware or a combination thereof. The units 210 to 250 may all be implemented in the PCU 200 in a single network node in the communications system. However, a distributed implementation is also possible, with the units 210 to 250 provided in different network nodes. For example, the functionalities of the generators 240 and 250 could be implemented in different base stations.

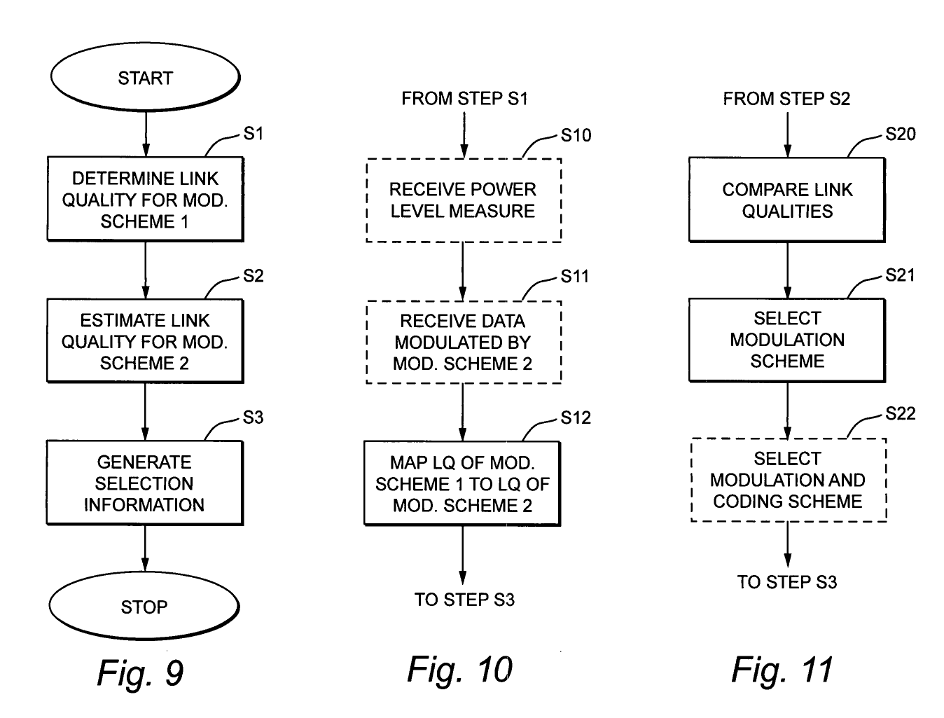

FIG. 9 is a flow diagram illustrating a method of generating decision or selection information for selection of a modulation scheme for a mobile unit. The method starts in step S1, where the mobile unit performs modulation-scheme-dependent signal or link quality measurements on radio blocks or bursts received on a communications link from a base station. Based on these measurements a link quality measure for the currently employed modulation scheme (modulation scheme 1) is determined. In a next step S2, a corresponding link quality measure is estimated for the other available but currently non-employed modulation scheme(s) (modulation scheme 2). This estimation is performed based on the determined link quality for the current modulation and/or from the measurement results for that modulation. Finally, in step S3, selection information is generated based on the determined and estimated link quality measures. This information will be used for selection of a suitable modulation scheme and/or MCS to use for the mobile unit. The method then ends.

FIG. 10 is a flow diagram illustrating an embodiment of the estimation step of FIG. 9 in more detail. The method continues from step S1. In a next step S10, the mobile unit receives transmission power level data from the base station communicating with the mobile unit. The mobile unit can now determine a respective power associated with the different modulations based on this power data. Such power information is used in the process for the determination of the modulation-dependent link quality measures. The mobile unit further intermittently or periodically receives data/blocks modulated with the currently not employed (or optimal) modulation scheme(s) in step S11. This allows the mobile unit to perform actual measurements also for this/these modulation(s) and thereby increases the accuracy of the link quality estimation for such modulation(s). This means that both the link quality measure for the currently employed modulation and these measurements, and optional power data, can be used in the estimation. In the next step S12, a look-up table is used with the measured and determined link quality measure for the currently employed modulation as input. Such a table includes a list of measures for the first modulation and corresponding values for the second modulations. Alternatively, one or several converting functions could be used with the measure of the first modulation as input and outputs an estimated link quality value for the second modulation. The table and function can be adapted for the functionalities and capabilities of the particular mobile unit. The method then continues to step S3 of FIG. 9.

FIG. 11 is a flow diagram illustrating additional steps of the method of FIG. 9. The method continues from step S2. In step S20 the link quality measures for the different modulations are compared in order to determine a best link quality and associated modulation. The currently best or most optimal modulation scheme is then selected in step S21 based on the comparison. In case the measures are BEPs, the modulation associated with a lowest BEP is typically selected in this step. In the optional step S22, a corresponding MCS for this selected modulation scheme is selected. Identification of the selected modulation and/or MCS is included in the selection information as the method continues to step S3.

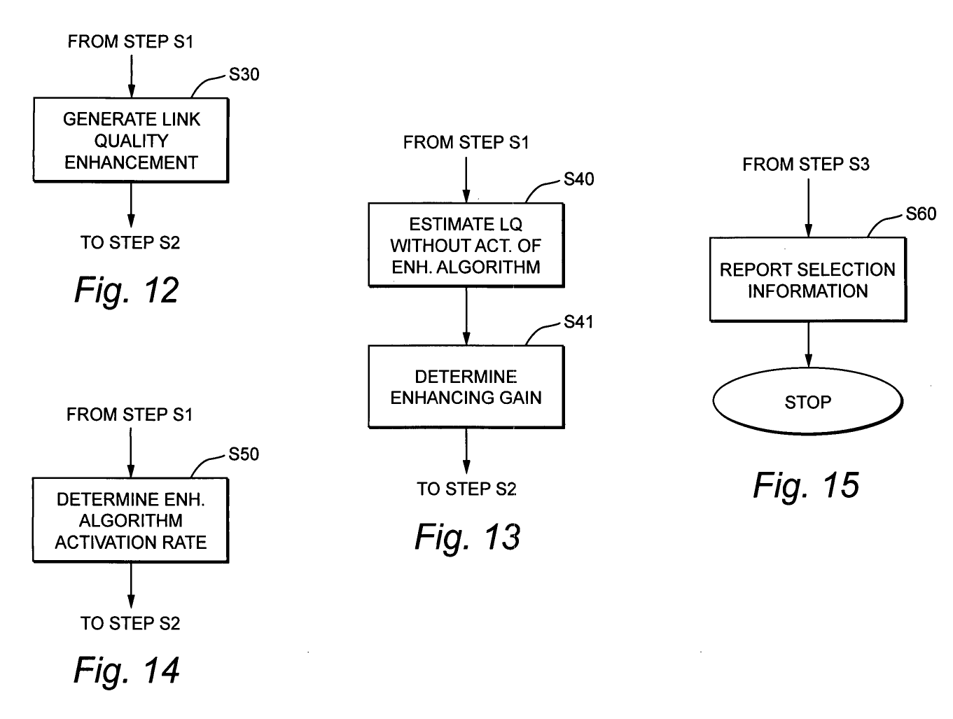

FIG. 12 is a flow diagram illustrating an additional step of the method of FIG. 9. The method continues from step S1. In step S30, a link quality enhancement is generated for the quality enhancing algorithm operational on data modulated using a subset, e.g. one of, the available modulation schemes. This quality enhancement is used further in the estimation process of the next step S2 and/or is included in the selection information.

FIG. 13 is a flow diagram illustrating an embodiment the enhancement generating step of FIG. 12. The method continues from step S1. In a next step S40, the link quality for the modulation scheme(s) associated with the enhancing algorithm is determined without activation of the algorithm. Step S41 compares this non-activated link quality with a corresponding link quality measure for the same modulation but with operation of the algorithm. The link quality enhancing gain can now be determined based on these two link quality measures. The method then continues to step S2.

FIG. 14 is a flow diagram illustrating another embodiment the enhancement generating step of FIG. 12. The method continues from step S1. In a next step S50, the activation ratio of the enhancing algorithm is determined. This ratio is typically expressed as the number of burst during which the algorithm was activated divided y the total number of burst during which the algorithm could potential have been activated. The link quality enhancement can, at least, be estimated based on such activation ratio, and possible other data such as average enhancing gain for the algorithm.

FIG. 15 is a flow diagram illustrating an additional step of the method of FIG. 9. The method continues from step S3. In a next step S60, the generated selection information is reported to a unit in the communications network performing the modulation selection, e.g. the PCU. This report could be intermittently or periodically transmitted to the PCU. Alternatively, or in addition, the report could be transmitted upon reception of a request from the PCU.

It will be understood by a person skilled in the art that various modifications and changes may be made to the present invention without departure from the scope thereof, which is defined by the appended claims.

1. A method of generating information for selection of a modulation scheme from multiple modulation schemes available for a mobile unit in a radio communications system, said method comprising the steps of:
said mobile unit detecting a first modulation-scheme-dependent link quality for a communications link employing a first modulation scheme;
said mobile unit estimating a second modulation-scheme-dependent link quality for at least a second modulation scheme based on said first link quality; and
generating said information for selection of a modulation scheme based on said first link quality d said second link quality.

2. The method according to claim 1, wherein said determining step comprises the steps of:
is said mobile unit performing measurements of data modulated with said first modulation scheme and received on said communications link;
said mobile unit determining said first link quality based on said measurements.

3. The method according to claim 1, wherein said estimating step comprises the step of said mobile unit determining said second link quality from a table mapping link qualities for different modulation-schemes, said link quality mapping being adapted for the capabilities of said mobile unit.

4. The method according to claim 1, wherein said estimating step comprises the step of said mobile unit determining said second link quality from a link-quality-mapping function using said first link quality as function input, said link-quality-mapping function being adapted for the capabilities of said mobile unit.

5. The method according to claim 1, further comprising the steps of:
said mobile unit comparing said first link quality and said second link quality; and
said mobile unit determining a preferred modulation scheme based on said comparison, wherein said information for selection of modulation scheme comprises a first identifier c said preferred modulation scheme.

6. The method according to claim 5, wherein said first identifier comprises a second identifier of a modulation and coding scheme associated with said preferred modulation scheme.

7. The method according to claim 1, further comprising the steps of:
intermittently communicating to said mobile unit, data modulated using said at least second modulation scheme on said communications link; and
said mobile unit determining link quality for said at least second modulation scheme based on said data modulated using said second modulation scheme, wherein said estimating step comprises estimating said second link quality based on said determined link quality for said at least second modulation scheme.

8. The method according to claim 1, wherein said mobile unit is adapted for employing a performance enhancing algorithm for enhancing the link quality of said communications link employing said first modulation scheme, said method comprising the step of said mobile unit generating a representation of a link quality performance enhancement caused by said performance enhancing algorithm, wherein said information for selection of a modulation scheme comprises said enhancement representation.

9. The method according to claim 8, wherein said enhancement representation generating step comprises the steps of:
said mobile unit estimating a third link quality for said first modulation scheme without usage of said performance enhancing algorithm; and
said mobile unit determining said enhancement representation based on said first link quality ad d third link quality

10. The method according to claim 8, wherein said enhancement representation generating step comprises the step of said mobile unit determining a rate of usage of said performance enhancing algorithm, said enhancement representation comprises said determined usage rate.

11. The method according to claim 8, wherein said performance enhancing algorithm is an interference suppressing algorithm.

12. The method according to claim 1, wherein each of said multiple modulation schemes is associated with a unique transmission power level used for communicating data on said communications link to said mobile unit, said method comprising the steps of:
determining a first transmission power level currently associated with said first modulation scheme;
determining a corresponding second transmission power level associated with said at least second modulation scheme, wherein said information for selection of a modulation scheme comprises at least one of:
said first transmission power level and said second transmission power level; and
a quantity derived from said first transmission power level and said second transmission power level.

13. The method according to claim 12, further comprising said step of a base station communicating with said mobile unit on said communications link reporting, to said mobile unit, at least one of:
said first transmission power level and said second transmission power level; and
said quantity.

14. The method according to clam 1, further comprising the step of said mobile unit reporting said generated information for selection of a modulation scheme to a modulation scheme selecting unit in said radio communications system.

15. A mobile unit adapted for generating information for selection of a modulation scheme from available multiple modulation schemes in a radio communications system, said mobile unit comprising:
means for determining a first modulation-scheme-dependent link quality for a communications link employing a first modulation scheme;
means for estimating a second modulation-scheme-dependent link quality for at least a second modulation scheme based on said first link quality; and
means for generating said information for selection of a modulation scheme based on said first link quality and said second link quality.

16. The mobile unit according claim 15, further comprising means for receiving data modulated with said first modulation scheme on said communications link, wherein said determining means is configured for performing link quality measurements of said received and modulated data.

17. The mobile unit according to claim 15, wherein said estimating means is configured for determining said second link quality from a table mapping link qualities for different modulation-schemes, said link quality mapping being adapted for the capabilities of said mobile unit.

18. The mobile unit according to claim 15, wherein said estimating means is configured for determining said second link quality from a link-quality-mapping function using said first link quality as function input, said link-quality-mapping function being adapted for the capabilities of said mobile unit.

19. The mobile unit according to 15, further comprising:
means for comparing said first link quality and said second link quality; and
means for determining a preferred modulation scheme based on said comparison, wherein said information for selection of modulation scheme comprises a first identifier of said preferred modulation scheme.

20. The mobile unit according to claim 19, wherein said first identifier comprises a second identifier of a modulation and coding scheme associated with said preferred modulation scheme.

21. The mobile unit according to claim 15, further comprising:
means for intermittently receiving data modulated using said at least second modulation scheme on said communications link; and
means for determining link quality for said at least second modulation scheme, wherein said estimating means is configured for determining said second link quality based on said determined link quality for said at least second modulation scheme.

22. The mobile unit according to claim 15, further comprising:
performance enhancing means for enhancing the link quality of said communications link employing said first modulation scheme;
means for generating a representation of a link quality performance enhancement caused by operation of said performance enhancing means, wherein said information generating means is configured for generating said information for selection of a modulation scheme based on said enhancement representation.

23. The mobile unit according to claim 22, further comprising means for estimating a third modulation-dependent link quality for said first modulation scheme without activation of said performance enhancing means, wherein said enhancement representation generating means is configured for determining said enhancement representation based on said first link quality and said third link quality for said first modulation scheme without usage of said performance enhancing algorithm.

24. The mobile unit according to claim 22, wherein said enhancement representation generating means is configured for determining a rate of activation of said performance enhancing means, said enhancement representation comprises said determined activation rate.

25. The mobile unit according to claim 22, wherein said performance enhancing means is configured for enhancing the link quality using an interference suppressing algorithm.

26. The mobile unit according to claim 15, wherein each of said multiple modulation schemes is associated with a unique transmission power level used for communicating data on said communications link to said mobile unit, said mobile unit comprising means for receiving, from a base station communicating said data, a transmission power measure selected from at least one of:
a first transmission power level currently associated with said first modulation scheme and a second transmission power level associated with said at least second modulation scheme; and
a quantity derived from said first transmission power level and said second transmission power level, wherein said estimating means is configured for estimating said second link quality based on said received transmission power measure.

27. The mobile unit according to claim 15, further comprising means for reporting said generated information for selection of a modulation scheme to a modulation scheme selecting unit in said radio communications system.

28. An information generating unit adapted for arrangement in a mobile unit and for generating information for selection of a modulation scheme from multiple available modulation schemes in a radio communications system, said unit comprising:
means for providing a first modulation-scheme-dependent link quality for a communications link employing a first modulation scheme;
a quality estimator for estimating a second modulation-scheme-dependent link quality for at least a second modulation scheme based on said first link quality; and
a first generator for generating said information for selection of a modulation scheme based on said first link quality and said second link quality.

29. The unit according to claim 28, further comprising:
a comparator for comparing said first link quality and said second link quality; and
means for determining a preferred modulation scheme based on said comparison, wherein said information for selection of modulation scheme comprises a first identifier of said preferred modulation scheme.

30. The unit according to claim 29, wherein said first identifier comprises a second identifier of a modulation and coding scheme associated with said preferred modulation scheme.

31. The unit according to claim 29, further comprising:
performance enhancing means for enhancing the link quality of said communications link employing said first modulation scheme;
a second generator for generating a representation of a link quality performance enhancement caused by operation of said performance enhancing means, wherein said first generator is configured for generating said information for selection of a modulation scheme based on said enhancement representation.

32. A modulation scheme selecting unit arranged in a radio communications system for selecting a modulation scheme from multiple modulation schemes available for a mobile unit and adapted for usage on a communications link between a base station and said mobile unit, said unit comprising:
means for receiving decision information originating from said mobile unit, said decision information comprises a first modulation-scheme-dependent link quality for said communications link employing a first modulation scheme and a second modulation-scheme-dependent link quality for at least a second modulation scheme, said second link quality being generated based on said first link quality; and
means for selecting a modulation scheme for usage for said communications link to said mobile unit based on said received decision information.

33. The unit according to claim 32, further comprising means for intermittently transmitting a modulation scheme exchange command to said base station, said exchange command urging said base station to intermittently communicate data modulated employing said at least second modulation scheme to said mobile unit on said communications link.
